(19) United States
(12) Patent Application Publication
(10) Pub. No.: US 2005/0114024 A1
(43) Pub. Date: May 26, 2005

(54) System and method for navigating using a digital compass

(75) Inventors: Misty D. Benham, San Antonio, TX (US); Joseph G. Wiegand, Conklin, NY (US)

Correspondence Address: FOLEY & LARDNER, 777 EAST WISCONSIN AVENUE, SUITE 3800, MILWAUKEE, WI, 53202-5308, US

(73) Assignee: Johnson Outdoors Inc.

(21) Appl. No.: 10/961,414

(22) Filed: Oct. 8, 2004

Related U.S. Application Data
(60) Provisional application No. 60/510,658, filed on Oct. 10, 2003.

(30) Foreign Application Priority Data
Mar. 11, 2004 (CA) 2460709

(51) Int. Cl. G01C 21/26

(52) U.S. Cl. 701/224; 701/200

(57) ABSTRACT

A method for configuring a digital compass processor to provide a desired bearing. The method includes receiving a first bearing in the digital compass processor based on an alignment of a first end of a direction of travel line with a current location on a map and an alignment of a second end of a direction of travel line with a desired destination on the map, receiving a second bearing in the digital compass processor based on an alignment of the direction of travel line with an indicator of map north, and calculating a desired direction of travel based on the first and second bearings using the digital compass processor.

### CROSS-REFERENCE TO RELATED PATENT APPLICATIONS

This application is an application claiming the benefit under 35 USC 119(e) from U.S. application Ser. No. 60/510,658, filed Oct. 10, 2003, incorporated herein by reference in its entirety.

### BACKGROUND OF THE INVENTION

The present invention relates generally to the field of digital compasses. More specifically, the present invention relates to the field of systems and methods for facilitating navigation using a digital compass.

Traditional compasses generally include a magnet or magnetic sensor. The magnet or magnetic sensor is configured to be mounted over a faceplate displaying traditional directional indicators (North, South, East, West). The magnet or magnetic sensor will continuously indicate the direction of magnetic north, such that a person may determine a heading direction based on viewing the magnet or displayed information from the magnetic sensor.

Compasses are often used to assist in navigation. For example, a compass user may desire to travel in a specific direction, referred to as a direction of travel or a desired bearing. Accordingly, the user may point the traditional compass in the direction of travel and memorize or use a bezel to obtain an offset from magnet north for the direction of travel. The user may then maintain the direction of travel by maintaining the same offset using the bezel or their memory.

Problems can occur when a user is reading a map or chart to obtain a direction of travel or where a compass does not include a bezel. When using a map, the map must first be oriented such that the north arrow on the map aligns with north from the compass. If it is not properly aligned, the direction of travel will be incorrect. Further, this calculation may be further complicated by calculation of declination, a difference between magnetic north shown on a compass and true north used in mapmaking.

What is needed is a system and method for utilizing a digital compass including a base plate to facilitate navigation. What is further needed is such a system and method configured to facilitate calculation of a desired direction of travel based on a desired direction of travel on a map. What is further needed is such a system and method that can easily account for declination.

It would be desirable to provide a system and/or method that provides one or more of these or other advantageous features. Other features and advantages will be made apparent from the present specification. The teachings disclosed extend to those embodiments which fall within the scope of the specification, regardless of whether they accomplish one or more of the aforementioned needs.

### SUMMARY OF THE INVENTION

One embodiment of the invention relates to a method for configuring a digital compass processor to provide a desired bearing. The method includes receiving a first bearing in the digital compass processor based on an alignment of a first end of a direction of travel line with a current location on a map and an alignment of a second end of a direction of travel line with a desired destination on the map, receiving a second bearing in the digital compass processor based on an alignment of the direction of travel line with an indicator of map north, and calculating a desired direction of travel based on the first and second bearings using the digital compass processor.

Another embodiment of the invention relates to a digital compass. The digital compass includes a base plate including a direction of travel line and a digital compass processor mounted to the base plate and configured to receive a first bearing representative of a desired direction of travel based on alignment of the direction of travel line with a desired destination on a map and a second bearing representative of north on the map and calculate a desired direction of travel based on the first and second bearings.

Yet another embodiment of the invention relates to a method for configuring a compass to provide a desired bearing. The method includes receiving a first bearing based on an alignment of a direction of travel line with a desired destination, receiving a second bearing based on an alignment of the direction of travel line with an indicator of north, and calculating a desired direction of travel based on the first and second bearings.

Other features and advantages of the present invention will become apparent to those skilled in the art from the following detailed description and accompanying drawings. It should be understood, however, that the detailed description and specific examples, while indicating preferred embodiments of the present invention, are given by way of illustration and not limitation. Many modifications and changes within the scope of the present invention may be made without departing from the spirit thereof, and the invention includes all such modifications.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is an perspective view of a digital compass assembly 100, according to an exemplary embodiment;

FIG. 2 is a top-down view of digital compass assembly 100, according to an exemplary embodiment;

FIG. 3 is a top down view of a display face for the digital compass assembly, according to an exemplary embodiment;

FIG. 4 is a flowchart illustrating a method for configuring a compass to indicate a desired bearing, according to an exemplary embodiment; and

FIG. 5 is an exploded view of a digital compass assembly 500 according to an alternative embodiment.

### DETAILED DESCRIPTION OF THE PREFERRED EMBODIMENTS

Before describing in detail the particular system and method, it should be observed that the structure, methods, functions, control, and arrangement of conventional components and circuits have, for the most part, been illustrated in the drawings by readily understandable block representations and schematic diagrams, in order not to obscure the disclosure with structural details which will be readily apparent to those skilled in the art, having the benefit of the description herein. Further, the invention is not limited to the particular embodiments depicted in the exemplary diagrams, but should be construed in accordance with the language provided herein.

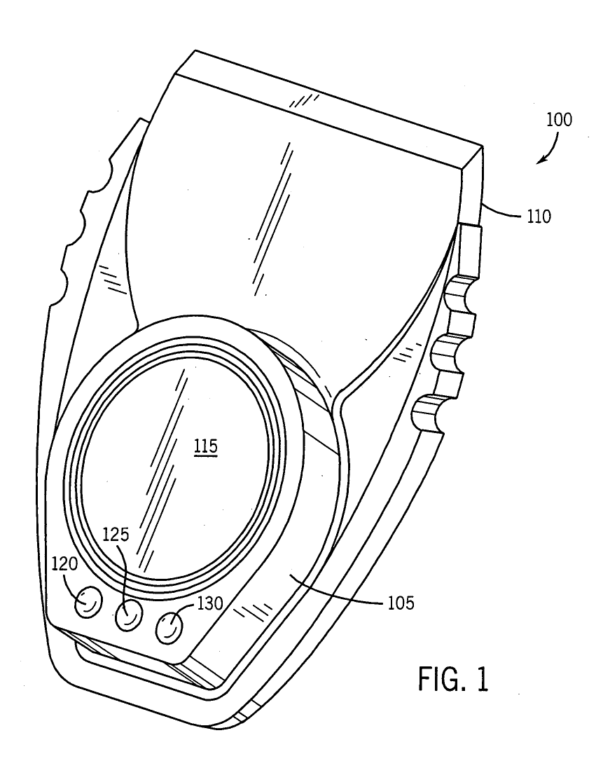

Referring to FIG. 1, FIG. 1 is a perspective view of a digital compass assembly 100, according to an exemplary embodiment. Digital compass assembly 100 includes a digital compass 105, a base plate 110, a display 115, and first second and third input buttons 120, 125 and 130, respectively.

Digital compass 105 is any type of digital compass configured to indicate at least a magnetic north direction and a current bearing. According to an exemplary embodiment, digital compass 105 includes a magnetic sensor configured to convert magnetic fields into a differential output voltage. The magnetic sensor may be configured to interact with a digital compass processor, described below, to provide a current bearing value based on the differential output voltage. The current bearing value is the direction the digital compass is pointed relative to the magnetic field sensed by the magnetic sensor. The digital compass processor is configured to receive the differential output voltage and calculate the current bearing value.

Digital compass 105 further includes the digital compass processor (not shown) configured to provide functions for use by a user of digital compass 105. The digital compass processor may be any type of processor configured to receive or calculate at least one value, perform an action on the at least one value, and provide an output value. The digital compass processor may be an integrated circuit, a computer, software, hardware, or any other implementation configured to provide the functionality described herein. The functions provided are those functions described herein and any additional function that may be desirable to a user of a digital compass such as a clock, a stopwatch, and alarm, etc.

The digital compass processor may be further configured to calculate other values based on the determination of the current bearing. For example, the current bearing is provided relative to the magnetic north sensed by the magnetic sensor. Accordingly, the digital compass may determine and provide as output a magnetic north value.

Further, the digital compass processor may be configured to provide a true north value. Magnetic north represented by the earth's magnetic field is displaced from true north represented by the north pole of the earth. Maps are generally drawn based on true north rather than magnetic north. The difference between magnetic north and true north is referred to as declination. Declination varies depending on a user's position on the earth. Accordingly, digital compass 105 may further include a declination correction function. This function will allow a user to correct for declination such that the north value provided by digital compass 105 will correspond with true north as shown on a map, allowing for more precise navigation.

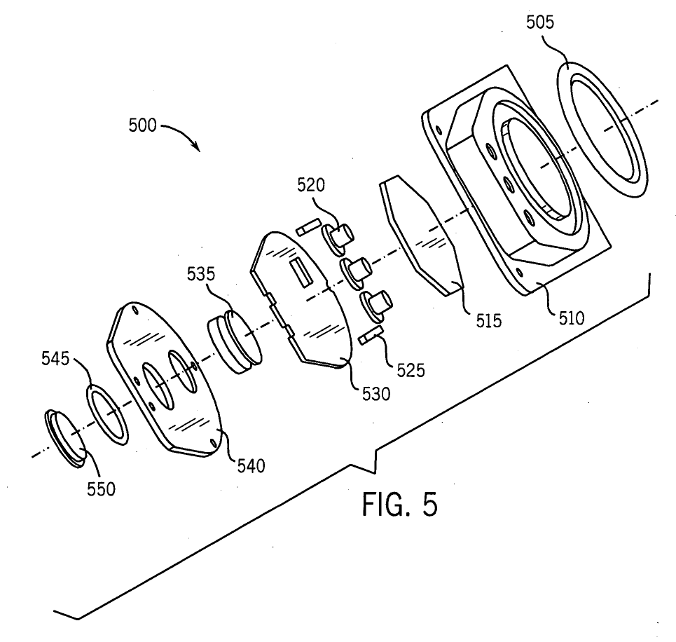

Digital compass 105 further includes a bearing feedback function. The bearing feedback function is used to indicate whether a user's current bearing or direction of travel corresponds to a desired bearing or direction of travel as will be further discussed below with reference to FIG. 4.

Digital compass 105 may further include a memory. The memory may be any type of memory configured to store data in a persistent or non-persistent manner, such as flash memory, EPROM memory, RAM memory, ROM memory, etc. Advantageously, including memory allows digital compass 105 to store and retrieve information received from the user, such as a desired direction of travel, or maintained by the digital compass processor, such as clock information.

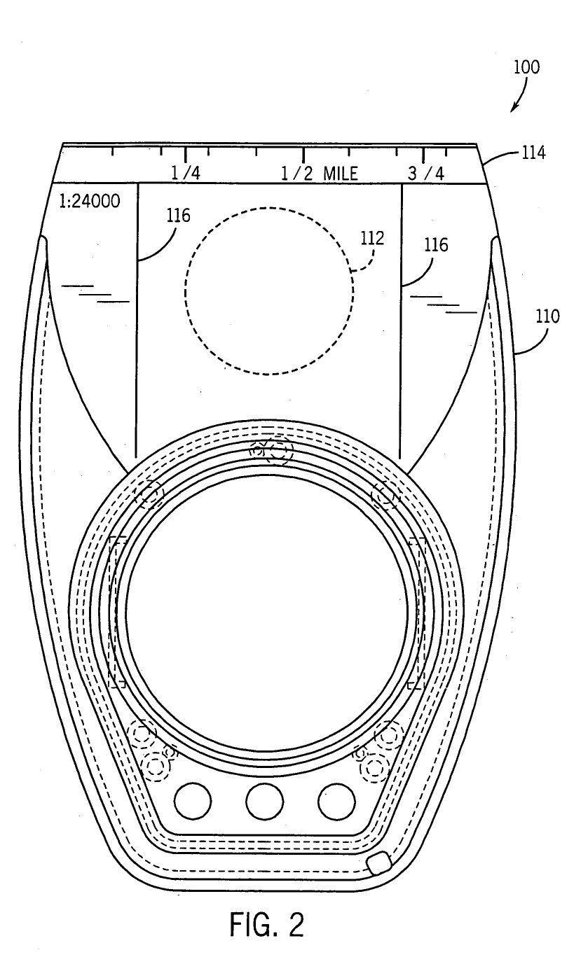

Referring now to FIG. 2, FIG. 2 is a top-down view of digital compass assembly 100 according to an exemplary embodiment. FIG. 2 illustrates base plate 110 in further detail. Base plate 110 is any type of mounting configured to receive digital compass 105. According to an exemplary embodiment, base plate 110 is formed from plastic in a roughly rectangular shape. According to alternative embodiments, base plate 110 may be formed from any type of material in any shape. Base plate 110 is generally formed, at least in part, from clear plastic such that a map may be read through base plate 110 when base plate 110 is placed on top of the map. Base plate 110 includes an integral magnifying lens 112, a map scale 114, and two direction of travel lines 116 according to an exemplary embodiment. Magnifying lens 112 and map scale 114 may be used to facilitate map reading and navigation calculations. According to alternative embodiments, magnifying lens 112 and map scale 114 may be omitted or modified. For example, map scale 114 may be modified to include a different scale based on the type of map scale prevalent in the area digital compass assembly 100 is generally used.

Direction of travel lines 116 are imprinted on base plate 110 in a clear section such that when digital compass assembly 100 is placed on top of a map, direction of travel lines 116 will be seen overlaying the map. According to an exemplary embodiment, direction of travel lines 116 may be used in conjunction with a map to indicate a desired direction of travel relative to the map north as will be further discussed below with reference to FIG. 4.

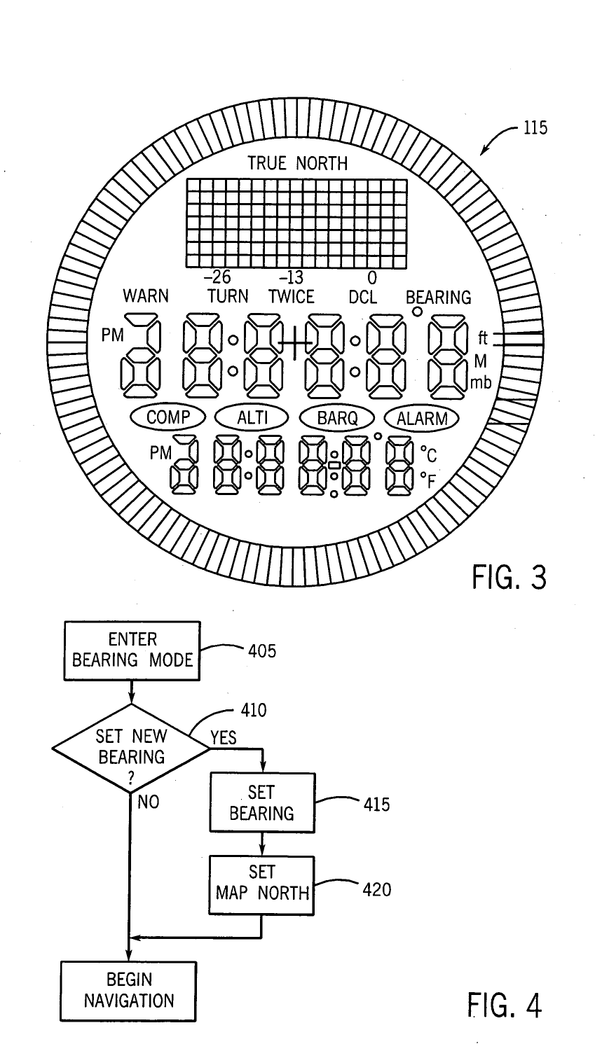

Referring now to FIG. 3, FIG. 3 is a top down view of display 115 according to an exemplary embodiment. Display 115 is a liquid crystal display (LCD) configured to display easy to read information. Display 115 includes indicators configured to facilitate understanding and use of the information currently being display on display 115. For example, where a declination value has been entered as described above with reference to FIG. 1, a “TRUE NORTH” indicator may be displayed to indicate that the compass is displaying values based on true north as opposed to magnetic north. Further, a warning indicator may be displayed when the magnetic sensor, described above with reference to FIG. 1 detects magnetic interference or detects that digital compass assembly 100 is not level, either of which may interfere with the output provided by the magnetic sensor. The display may further display instructional indicators configured to guide a user through a function configured to set a desired bearing, described below with reference to FIG. 4. Although display 115 is shown according to a specific embodiment, any display configuration may be utilized to implement the functions described herein.

Referring again to FIG. 1, first, second, and third input buttons 120, 125 and 130 provide a user interface configured to allow a user to provide input to digital compass 105. Although the input buttons are described as buttons, the input may alternatively be provide by switches, a touch screen, voice recognition, etc. According to an exemplary embodiment, the input buttons are rubber buttons mounted to the face of digital compass 105. The input buttons allow a user to provide input, configure, reconfigure, or receive output from digital compass 105. For example, the buttons may be used to initiate a calibration function, initiate a desired bearing input sequence, described below with reference to FIG. 4, change the type of information displayed, etc. Although three input buttons are shown, digital compass assembly 100 may include more, fewer, or different configurations of input buttons according to alternative embodiments.

Referring now to FIG. 4, FIG. 4 is a flowchart 400 illustrating a method for configuring a compass to indicate a desired bearing or direction of travel, according to an exemplary embodiment. The desired bearing is a direction that a user of digital compass assembly 100 wishes to travel.

In a step 405, the user initiates a training mode to train digital compass assembly 100 to receive a desired direction of travel. The user initiates training by depressing and holding first input button 120 until display 115 displays a “BER” indicator (i.e. “bearing”). The “BER” indicator indicates that digital compass 105 is ready to begin training.

The user then depresses third button 130 to begin training in a step 410. Upon depression of third button 130, display 115 will display a query whether the user wishes to enter a new bearing. Display 115 may display “NO” in an area associated with first button 120 and “YES” in an area associated with third button 130. If the user depresses first button 120, a current bearing stored in memory is used as a desired direction of travel and the user can begin navigating in a step 425, further described below.

If the user depress third button 130, display 115 will display “DT” for direction of travel and digital compass 105 will await user input. To determine a desired direction of travel, a user may place digital compass assembly 100 on a map. The user the aligns one end of direction of travel lines 116 with the user's current location. The other end of the direction of travel line 116 is pointed in the desired direction of travel on the map. When digital compass assembly 100 is properly positioned, the user depresses second button 125 to indicate the desired direction of travel on the map in a step 415.

However, the direction of travel on the map is not a correct direction of travel relative to magnetic north or true north. Accordingly, the user must input a bearing representative of map north in a step 420. The user moves digital compass assembly 100 on the map, without moving the map, such that a direction of travel line 116 is aligned with an arrow on the map representing the direction of map north. When digital compass assembly 100 is properly positioned, the user depresses third button 130 to indicate the direction of north on the map. Upon depression of third button 130, the bearing of the desired direction of travel is displayed to the user.

Thereafter, the user may begin navigating in a step 425. To navigate, a user holds digital compass assembly 100 and spins in a circle until digital compass assembly 100 is facing in the desired direction of travel indicated in step 415. The desired direction of travel is the direction of travel relative to magnetic or true north.

Digital compass assembly 100 may be configured to provide an indication to the user that the user is facing in the correct direction with the current bearing corresponds with the desired direction of travel. For example, digital compass assembly 100 may provide an audio indication that the user is facing in the correct direction. Further, the audio signal may be customized based on how close a user is to the correct direction. For example, digital compass assembly 100 may beep slowly when a user within 4 degrees of the desired direction of travel and beep rapidly when a user is with 2 degrees of a desired direction of travel. Alternatively, other indications may be provided such as a numerical offset from a desired direction of travel, an arrow indicative of the desired direction of travel, a flashing light operating similar to the audio signal, etc.

Although the method described above includes using a map to determine a desired bearing, a desired bearing may alternatively be calculated without using a map. The user may simply point a direction of travel line 116 in the desired direction in step 415 to indicate the desired direction of travel, for example where a destination is within line of sight. Thereafter, the user may align the direction of travel line 116 with north as provided by digital compass 105 in step 420. Thereafter, the desired bearing will be stored without the use of a map.

Referring now to FIG. 5, FIG. 5 is an exploded view of a digital compass assembly 500 according to an alternative embodiment. Digital compass assembly 500 includes a bezel 505, a base plate 510, a display 515, input buttons 520, silica conductive 525, printed circuit board 530, battery 535, bottom 540, seal 545 and battery cover 550. FIG. 5 illustrates that digital compass assembly 100 may include a variety of components and configurations to provide the functions described herein.

While the detailed drawings, specific examples and particular formulations given describe preferred and exemplary embodiments, they serve the purpose of illustration only. The inventions disclosed are not limited to the specific forms shown. For example, the methods may be performed in any of a variety of sequence of steps. The hardware and software configurations shown and described may differ depending on the chosen performance characteristics and physical characteristics of the computing devices. For example, the type of computing device, communications bus, or processor used may differ. The systems and methods depicted and described are not limited to the precise details and conditions disclosed. Furthermore, other substitutions, modifications, changes, and omissions may be made in the design, operating conditions, and arrangement of the exemplary embodiments without departing from the scope of the invention.

1. A method for configuring a digital compass processor to provide a desired bearing, comprising:
receiving a first bearing in the digital compass processor based on an alignment of a first end of a direction of travel line with a current location on a map and an alignment of a second end of a direction of travel line with a desired destination on the map;
receiving a second bearing in the digital compass processor based on an alignment of the direction of travel line with an indicator of map north; and
calculating a desired direction of travel based on the first and second bearings using the digital compass processor.

2. The method of claim 1, further comprising providing an indication representative of the desired direction of travel.

3. The method of claim 2, wherein the indication representative of the desired direction of travel is an arrow pointing in the desired direction of travel.

4. The method of claim 2, wherein the indication representative of the desired correction of travel includes providing an audio indication that the compass is pointing in the desired direction of travel.

5. The method of claim 4, wherein the audio indication may be varied based on the degree of deviation from the desired direction of travel.

6. The method of claim 2, further comprising providing a warning indication if magnetic interference is detected that may interfere with the indication representative of the desired direction of travel.

7. The method of claim 1, further comprising providing an indication of north relative to the desired direction of travel.

8. The method of claim 1, further comprising providing a warning indication if the digital compass is not level.

9. A digital compass, comprising:
a base plate including a direction of travel line; and
a digital compass processor mounted to the base plate and configured to receive a first bearing representative of a desired direction of travel based on alignment of the direction of travel line with a desired destination on a map and a second bearing representative of north on the map and calculate a desired direction of travel based on the first and second bearings.

10. The digital compass of claim 9, further comprising a digital compass display configured to provide an indication representative of the desired direction of travel.

11. The digital compass of claim 10, wherein the digital compass display is an LCD display.

12. The digital compass of claim 10, wherein the indication representative of the desired direction of travel is an arrow pointing in the desired direction of travel.

13. The digital compass of claim 10, wherein the indication representative of the desired correction of travel is an audio indication that the digital compass is pointing in the desired direction of travel.

14. The digital compass of claim 13, wherein the audio indication may be varied based on the degree of deviation from the desired direction of travel.

15. The digital compass of claim 10, herein the digital compass processor is configured to provide a warning indication if magnetic interference is detected that may interfere with the indication representative of the desired direction of travel.

16. The digital compass of claim 9, wherein the digital compass display is further configured to display an indication of north relative to the desired direction of travel.

17. The digital compass of claim 9, wherein the digital compass processor is configured to provide a warning indication if the digital compass is not level.

18. The digital compass of claim 9, further comprising a user interface configured to facilitate entry of the first and second bearings.

19. The digital compass of claim 18, wherein the user interface comprises one or more buttons.

20. A method for configuring a compass to provide a desired bearing, comprising:
receiving a first bearing based on an alignment of a direction of travel line with a desired destination;
receiving a second bearing based on an alignment of the direction of travel line with an indicator of north; and
calculating a desired direction of travel based on the first and second bearings.

21. The method of claim 20, further comprising providing an indication representative of the desired direction of travel.

22. The method of claim 21, wherein the indication representative of the desired direction of travel is an arrow pointing in the desired direction of travel.

23. The method of claim 21, wherein the indication representative of the desired correction of travel includes providing an audio indication that the compass is pointing in the desired direction of travel.

24. The method of claim 23, wherein the audio indication may be varied based on the degree of deviation from the desired direction of travel.

25. The method of claim 20, further comprising providing a warning indication if magnetic interference is detected that may interfere with the indication representative of the desired direction of travel.

26. The method of claim 20, further comprising providing a warning indication if the digital compass is not level.
